(19) United States
(12) Patent Application Publication
(10) Pub. No.: US 2008/0202299 A1
(43) Pub. Date: Aug. 28, 2008

(54) Cutting device for substantially linear workpieces and method for cutting substantially linear workpieces

(76) Inventor: Heiner Kudrus, Eupen (BE)

Correspondence Address: COLLARD & ROE, P.C., 1077 NORTHERN BOULEVARD, ROSLYN, NY, 11576, US

(21) Appl. No.: 12/069,152

(22) Filed: Feb. 7, 2008

(30) Foreign Application Priority Data
Feb. 8, 2007 (DE) 10 2007 007 061.8

(51) Int. Cl. B26D 1/56; B23D 25/02

(52) U.S. Cl. 83/37; 83/284; 83/13

(57) ABSTRACT

In order to further develop cutting methods for linear workpieces, the invention proposes a cutting device for substantially linear workpieces, in particular for substantially continuously fed linear workpieces, in which a cutting carriage is moved together with the workpiece and a cutting device provided on the cutting carriage cuts the workpiece during this movement and in which the cutting device is characterised by at least two successively arranged cutting carriages.

The invention relates on the one hand to a cutting device for substantially linear workpieces, in particular for substantially continuously fed linear workpieces in which a cutting carriage is moved jointly with the workpiece and a cutting device provided on the cutting carriage cuts the workpiece during its movement. Furthermore, the invention relates to a method of separating substantially linear workpieces, in particularly substantially continuously fed linear workpieces.

Cutting devices for substantially linear workpieces are known from the prior art such as, for example, for tubes made of copper or aluminium which can also be processed in coil form.

Thus, various tubes are cut into tube pieces of predetermined tube lengths, for example, by means of circulating blades which cut the tube over its circumference, whereby the circulating blade is set against the tube at the desired location and is then guided around the tube. Optionally, such cutting is supported by additionally subsequently exposing the tube to tensile or bending stress. In this case, the circulating blades do not need to completely cut through the wall of the tube at the provided cutting point since the actual parting process then takes place due to the bending or pulling. A corresponding example is disclosed in US 4,552,047.

In particular, compared with material-removing cutting processes in which a tube is cut into tube pieces of arbitrary lengths, for example, by means of a cold circular saw, cutting process using circulating blades are characterised in that substantially less or no loss of material is achieved during the cutting.

Cutting processes using circulating blades are described in detail, for example, in the specialist journal Bander, Bleche, Rohre 1-1980 in the article by R. Bardolete, “Burr-free and geometrically true cutting to length”.

In addition, a stationary device is described in U.S. Pat. No. 4,111,346 by means of which tubes can be cut into different lengths, where the tubes are partially cut on their circumference and then broken off so that the tube breaks off at the partial cut.

Furthermore, flying shears are sufficiently known from the prior art, and can also be used for cutting moving workpieces whereby they are moved with the workpiece and then cut through the tube at a specific point with a rapid impact. However, such impact cutting has the disadvantage that the tube ends are subjected to considerable stresses and are usually deformed. U.S. Pat. No. 3,771,393 discloses a cutting device comprising a rotating cutting blade which is moved with the workpiece, whereby this also subjects to the tube ends to considerable stress.

It is the object of the present invention to further develop and effectively configure known methods for cutting tubes, in particular circulating blades.

The object of the invention is achieved by a cutting device for substantially linear workpieces, in particular for substantially continuously fed linear workpieces, in which a cutting carriage is moved together with the workpiece and a cutting device provided on the cutting carriage cuts the workpiece during this movement and in which the cutting device is characterised by at least two successively arranged cutting carriages.

As a result of the two successively arranged cutting carriages, it is possible to cut even short tube pieces without reducing the conveying speed of the workpiece to be cut for this purpose in such a manner that the performance of the entire cutting device must be inefficiently throttled. In the present case, it is rather possible to adapt the tube length of the tube pieces by modulating the relative speed and/or the relative movement of the two cutting carriages with respect to one another and/or the conveying speed of the workpiece. Ideally, even short tube lengths can be cut at the maximum conveying speed of the tube.

The cutting carriages advantageously each run through a cyclic movement sequence where they can in particular execute a linear forward and backward movement. The movements of the cutting carriages are preferably synchronized, where this relates to the synchronization of the cyclic movements and in particular does not necessarily imply a synchronous movement of the cutting carriages. However, the cutting carriages can also be driven asynchronously as long as they are moved at the same speed as the tube during the actual cutting.

Accordingly, the object of the invention is also achieved by a method for cutting substantially linear workpieces, in particular substantially continuously fed linear workpieces, which is characterised in that two successively arranged cutting carriages are moved forwards and backwards with a phase difference.

By means of such a phase difference between the two cutting carriages, the tube lengths to be cut can be modulated in a manner not hitherto known. In this way, in particular variable workpiece lengths can be cut to length for a given distance between the cutting carriages and given workpiece speed.

A cutting device rotating around the workpiece can preferably be provided, this device being moved on a cutting carriage with the workpiece during the cutting and running around this workpiece during the cutting.

It is found to be advantageous if such a rotating parting or cutting devices such as, for example, one or a plurality of cutting blades, cut the workpiece whilst this workpiece is moved at a conveying speed. By this means, the cutting performance can advantageously be increased compared with methods in which the workpiece is not continuously moved forwards.

The object is likewise achieved by a method for cutting substantially linear workpieces, in particular substantially continuously fed linear workpieces, by means of a cutting device which is preferably moved with the workpiece during the cutting, wherein the workpiece is gripped on both sides of a parting surface and is cut under tension with the cutting device at the parting surface.

In this context, the term “parting surface” means a plane along which a workpiece is to be cut and ultimately is cut within the framework of the accuracy of the selected cutting method.

If a tube for cutting is cut under tensile stress, a cutting process can be executed more rapidly than during cutting without tensile stressing.

The fact that a workpiece is gripped on both sides of a parting surface and cut under tension with a cutting device at the parting surface is hitherto not yet known from the prior art. Although it is known from the article by B. Bardolette “Burr-free and geometrically true cutting to length” in the technical journal Bander, Bleche, Rohre 1-1980 and from U.S. Pat. No. 4,111,346 or U.S. Pat. No. 4,552,047 that workpieces can be partially cut and then separated by subsequently pulling or breaking, these documents do not, however, provide instructions to process a workpiece simultaneously under tension with a cutting device. By suitably matching the tensile forces to the cutting process which is taking place simultaneously, the cutting edge can advantageously be modulated as well as the cutting speed. This makes it possible to dispense with any further after-treatment of the parting surface, for example, any deburring, since a tear-off edge can be produced by the tension which, for example, does not project radially inwards or radially outwards over a tube wall. In particular, a cutting process under tension is not known in connection with a cutting carriage moved together with the workpiece.

One variant of the method provides that the cutting process and the pulling are matched to one another in such a manner that the parting edge thus produced comprises an expanded tube wall and/or a tear or break edge. This ensures that a tube is already separated before a cutting device has completely cut through the tube wall.

The object of the invention is also achieved independently of the preceding by a method for cutting substantially linear workpieces, in particular substantially continuously fed linear workpieces by means of a cutting device, which is moved with the workpiece during cutting, which is characterised in that the workpiece is gripped on both sides of a parting surface and is cut under tension and/or break. This solution certainly has the disadvantage that the movement sequences between the workpiece and the cutting carriage on the one hand and between the holder exerting the tension and a cutting device on the cutting carriage on the other hand are relatively complex. However, this can be countered in particular by arranging the holder and the cutting device on a cutting carriage. On the other hand, the solution has the surprising advantage that after cutting, the two workpiece parts are at a short distance from one another although they are still moving together with the cutting carriage so that subsequent workpiece guides or intermediate workpiece guides can convey the workpieces more simply separately from one another so that they can also be separated more easily. This problem does not occur with a stationary cutting device and stationary workpiece so that at this point the cutting under tension or breaking with a cutting carriage moving with the workpiece has surprising advantages.

In order that cutting carriages can be moved independently of one another, it is advantageous if at least one cutting carriage is driven independently of the other cutting carriage for its movement with the workpiece. By means of drives operating independently of one another, the speed of the cutting carriages can be varied with respect to one another in a structurally particularly simple fashion and thus the length of the separated workpiece sections can be modulated over the phase of the carriages.

For the adjustment of particularly short tube lengths, it is furthermore advantageous if the movement paths of the cutting carriages overlap. The cutting carriages each describe a movement path during their to and fro movement. If the movement paths of two cutting carriages overlap, a further variation in tube length is available. In this case, however, care must be taken to ensure that the cutting carriages run with overlapping movement paths phase-shifted with respect to one another to prevent any collision of the cutting carriages in the overlap region. In addition, as a result of the overlap, intermediate guides for the tube can be dispensed with since the transfer path from a first workpiece guide of a first cutting carriage to a second workpiece guide of a second cutting carriage can be reduced substantially by this means. This is particularly advantageous in connection with short tube lengths which have been cut by the first or front cutting carriage and must be transported further.

In some circumstances, the cutting carriages can run on separate guides. In this way, an overlap of the movement paths [can be achieved] which ultimately is not critical for the respective carriages per se but is merely important in relation to the assemblies of each cutting carriage which lie on the path of the workpiece or which embrace the workpieces. In this way, the distance between the cutting means or between the assemblies embracing the workpiece can be further reduced, such a configuration being advantageous in particular for cutting carriages in which the guide devices and the drives are substantially larger than any cutting means such as, for example, an arrangement of tensile-acting retaining devices and rotating cutting blades.

In order that sufficient tube guidance is provided along the workpiece axis in the case of two successively arranged cutting carriages, one embodiment provides that a workpiece guide is provided on at least one cutting carriage.

Advantageously such a movable workpiece guide can bridge partial sections between two workpiece guides which are provided, for example in a fixed position on the cutting device, in particular for tube pieces which have already been cut by means of the first cutting carriage and must be conveyed further to the second cutting carriage. This is particularly advantageous for two overlapping movement paths since a workpiece guide disposed between the cutting carriages would be in the way of the cutting carriage.

However, if the partial sections to be bridged exceed a critical length, it is advantageous to provide an intermediate workpiece guide which is disposed between two cutting carriages independently of their movement sequence. By means of such an intermediate workpiece guide, a workpiece which has already been cut can be moved in particular from a first cutting carriage to a second cutting carriage in a sufficiently guided manner without one of the two cutting means needing to be in engagement with the workpiece which has already been cut and needs to be conveyed further.

It is understood that the intermediate workpiece guide which has been described can be attached arbitrarily to the cutting device. In particular, the intermediate workpiece guide can be fixed in a displaceable manner. Thus, the intermediate workpiece guide can also be moved together with a workpiece, in particular to ensure the safest possible guidance and optionally to be able to pass the cutting carriage. However, it is structurally particularly simple if the intermediate workpiece guide is disposed in a fixed position.

A further embodiment provides that at least one intermediate workpiece guide is disposed so that it can move jointly with the workpiece. In this case, the intermediate workpiece guide can firmly grip the workpiece, at least in sections in order to optionally exert tensile or bending forces on the workpiece in cooperation with another device. However, it is also feasible that the intermediate workpiece guide has its own conveying means for the workpiece to ensure, for example, an advance or a braking of the workpiece. Alternatively, however, the intermediate workpiece guide can be configured passively so that it merely permits the workpiece to slide further in a guided manner.

In this context, it should be noted that optionally more than two cutting carriages can be provided. The number of cutting carriages depends in particular on the workpiece speed and the minimum cycle duration for the movement of the cutting carriages or the desired workpiece lengths to be cut to length. If these two characteristics cannot be matched to one another, a further cutting carriage is advantageous. Higher workpiece lengths can then be achieved by the previously described phase difference, whereas for a given workpiece speed and given minimum cycle time for the movement of the cutting carriages, the minimum workpiece length should be achieved with cutting carriages running round in phase.

A cutting device can comprise rotating means for chipless cutting of the workpiece.

Compared with the prior art, the present cutting device has the advantage that it operates substantially more rapidly than has hitherto been possible with fixed rotating cutting devices and in addition can operate with a clocked feed. In addition, compared with revolving impact shears, the present cutting device has the advantage that it leaves behind a substantially better cut and thus a substantially higher-quality parting-cutting point on the workpieces.

It is advantageous if the cutting means comprises a rotating cutting device. This ensures that a clean cut is formed running around the workpiece and an exact cut edge can be formed requiring no further after-treatment.

A particularly clean cut is formed if the cutting device comprises a cutting blade. In addition, cutting blades are very wear-resistant.

It is advantageous if the cutting blade is a rotating cutting blade circulating externally around the outside diameter. Particularly high cutting performance can be achieved by means of such an externally circulating cutting blade, where circulating rotating cutting blades are also technically well known per se and thus can be suitably controlled.

A particularly exact cutting of the linear workpiece is achieved if the cutting blade is a circulating blade having an inner cutting edge. This can reduce the risk of material compression particularly on the outside of the tube.

In addition, it is advantageous if the cutting device comprises a rotating chuck for a cutting tool. In particular, cutting blades can advantageously be mounted and guided by means of the rotating chuck.

In order to advantageously adjust a required change in diameter with regard to a tube to be cut on the cutting device, it is advantageous if the circulating chuck has radially displaceable cutting blade holders for at least one cutting tool and means for radial displacement of the cutting blade holder for a cutting process. The cutting blade holder can ensure secure guidance of the cutting tool or the cutting tools.

In order that the cutting device in particular has an especially radially compact structure, it is advantageous if the displacement means comprises a toggle lever wherein one arm of the toggle lever is preferably disposed on the cutting blade holder and the other arm of the toggle lever is disposed on a retaining part such as, for example, on retaining jaws for the cutting tool and the displacement means act on the elbow. By means of this toggle lever construction, axial input forces can be deflected particularly advantageously into radial retaining forces. In particular co-rotating assemblies are suitable as retaining parts, where these can be configured as radially displaceable, for example, for adjustment purposes so that different workpiece diameters can be processed simply.

In addition, it is advantageous if the displacement means comprise a thrust plate, preferably a thrust plate circulating with the cutting device. By this means, a plurality of blades and/or cutting tools can be synchronized particularly easily.

A particularly cost-effective embodiment provides that the separating device is opened by centrifugal forces. Opening the cutting device by means of centrifugal forces makes a restoring mechanism for radial displacement of the separating tools away from the workpiece superfluous.

In this case, it is particularly advantageous if the cutting tools circulate constantly or rotate continuously over at least two cutting processes. Starting and braking processes for the cutting tools which merely cost time and energy can be minimised in this way. In particular, larger masses whose acceleration processes accordingly cost more time and energy, such as adjusting motors or other drives, can then co-rotate. The centrifugal forces as described previously can then optionally be used particularly reliably and simply. For cutting, only the cutting device or cutting devices are accordingly adjusted and then opened again preferably without varying the rotational speed.

In order that the cutting device can be adjusted flexibly and particularly rapidly to different workpiece diameters, it is advantageous if the cutting device or the cutting apparatus has means for radial adjustment of the cutting means with respect to different workpiece diameters. The cutting means can then be radially adjusted by the radial adjusting means with respect to the workpiece axis in such a manner that the present cutting device can be adjusted even to large differences in workpiece diameters in a rapid and uncomplicated manner.

A particularly advantageous embodiment in this connection provides that the adjusting means comprise retaining jaws on which the cutting means or cutting-means holders are mounted.

In the present case, the term “retaining jaws” describes means for radial adjustment which are arranged radially around the workpiece axis and are mounted so that they are radially adjustable with respect to this workpiece axis. The retaining jaws are preferably only adjusted radially when the cutting device is to be adapted to a different workpiece diameter. In particular, the retaining jaws are not usually adjusted during the actual delivery of the cutting means for cutting, during cutting or after cutting. For the delivery process as well as for the opening, the cutting means themselves are arranged radially displaceably on the cutting carriage, preferably radially displaceably on the retaining jaws.

It has proved to be advantageous if a toggle lever, in particular an arm of a toggle lever, is mounted on the retaining jaws. Then the adjusting mechanism for the cutting means is thus mounted on the retaining jaws so that it can advantageously be adjusted with respect to the workpiece axis together with the retaining jaws.

If the retaining jaws are mounted radially adjustably on the cutting carriage with respect to a workpiece axis, the cutting carriage can easily be matched even to a range of different workpiece diameters.

Furthermore, the object of the invention is achieved by a cutting device for substantially linear workpieces, in particular for substantially continuously fed linear workpieces, in which a cutting carriage is moved together with the workpiece and a cutting device provided on the cutting carriage cuts the workpiece during this movement, which is characterised in that at least two retaining devices are provided on the carriage which, when viewed along the workpiece axis, are disposed on both sides of a cutting device, wherein at least one of the two retaining devices can be moved along the workpiece axis relative to the other retaining device and/or relative to the cutting carriage or relative to the cutting device.

By this means a workpiece can be cut under tension in a particularly simple manner whereby this then tears substantially earlier and in particular reliably under predefined conditions compared with when a cut is first made and a tensile stress is then applied to the linear workpiece.

By means of the retaining devices disposed on both sides of the cutting device, on the one hand a particularly exact retention and guidance of cut tube pieces can advantageously be ensured in some circumstances. In particular, additional forces such as, for example, tensile forces can be applied to the workpiece by means of the bilateral retaining devices and these substantially promote cutting processes on the workpiece as has already been described.

In this case, it has been found that as a result of cutting under simultaneous tensile stress, the tensile stress appears to influence the cutting process as a critical parameter. In this respect, for a predefined tensile stress which ultimately accordingly leads to a predefined deformation of the workpiece in the area of the parting point, the parting point can always be reliably executed as the same. For a predefined tensile stress, the cutting means such as, for example, a cutting blade can then circulate and cut until the cut is sufficiently deep so that the tensile stress ruptures the workpiece at the corresponding point.

It is understood that an intermediate workpiece guide disposed between two cutting carriages in particular independently of the movement sequence of the cutting carriages is advantageous for a cutting device regardless of the remaining features of the present invention. The same applies to the displacement means if this comprises a toggle lever and/or a thrust plate as well as for a cutting head to be opened by centrifugal forces and the means for radial adjustment of the cutting means.

Further advantages, aims and properties of the present invention are explained by reference to the description of the appended drawings which show the present cutting device as an example, its movement and cutting sequences as well as components of the cutting device.

In the figures

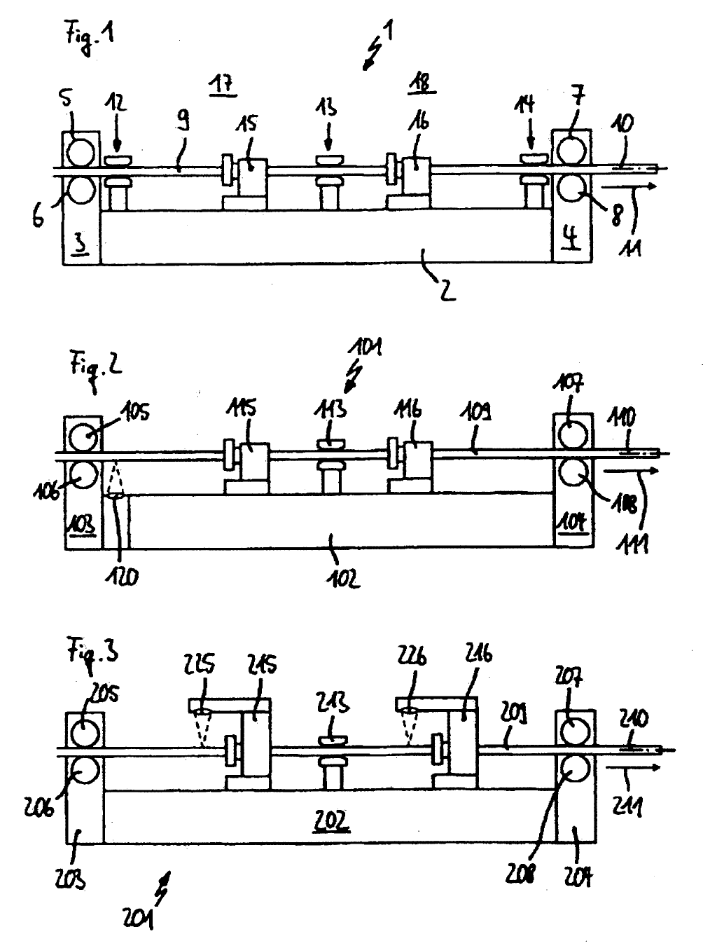

FIG. 1 is a schematic side view of a tandem cutter with two cutting carriages driven independently of one another,

FIG. 2 is a schematic side view of a tandem cutter with two cutting carriages driven independently of one another, and with stationary distance measuring means,

FIG. 3 is a schematic side view of a tandem cutter with two cutting carriages driven co-moving stationary distance measuring means,

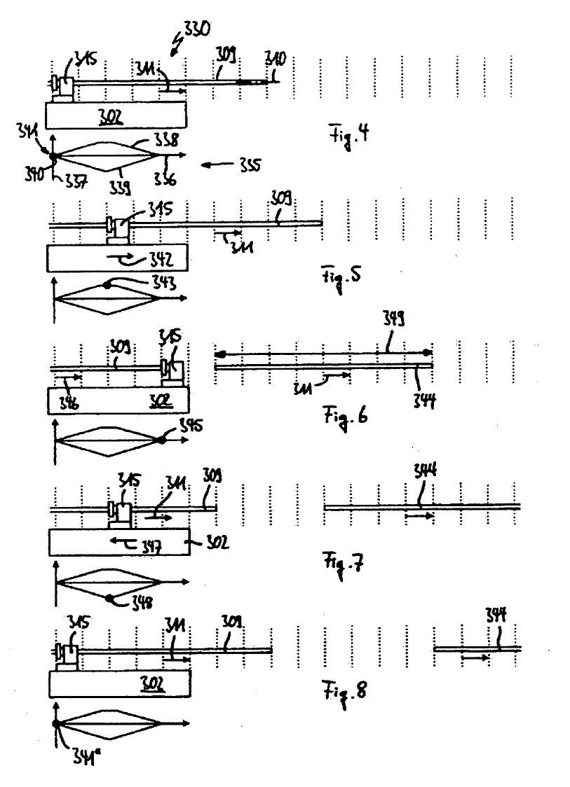

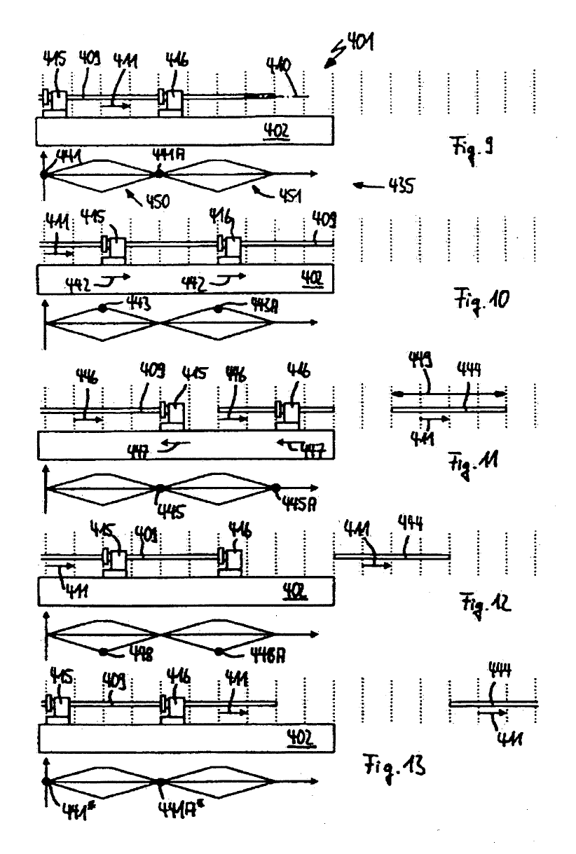

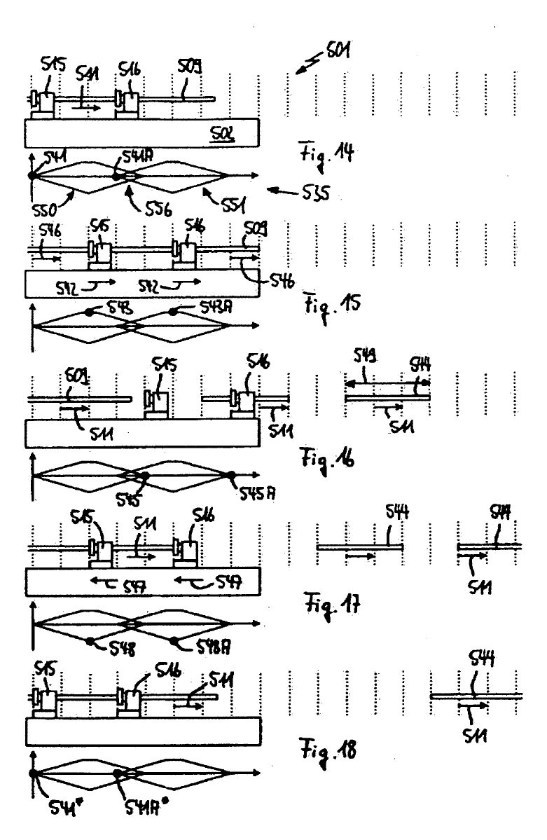

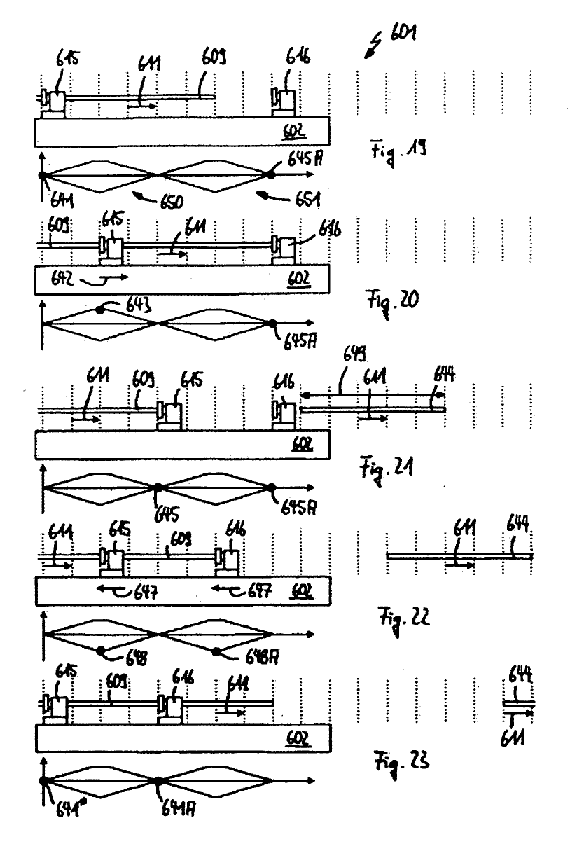

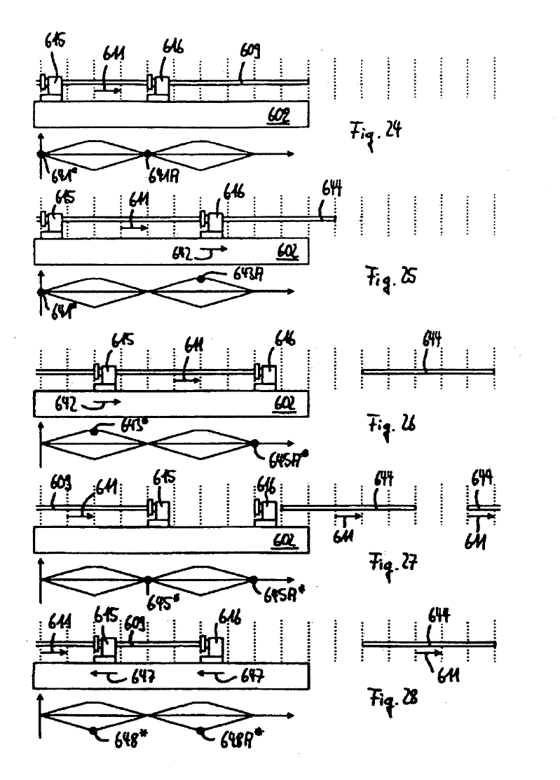

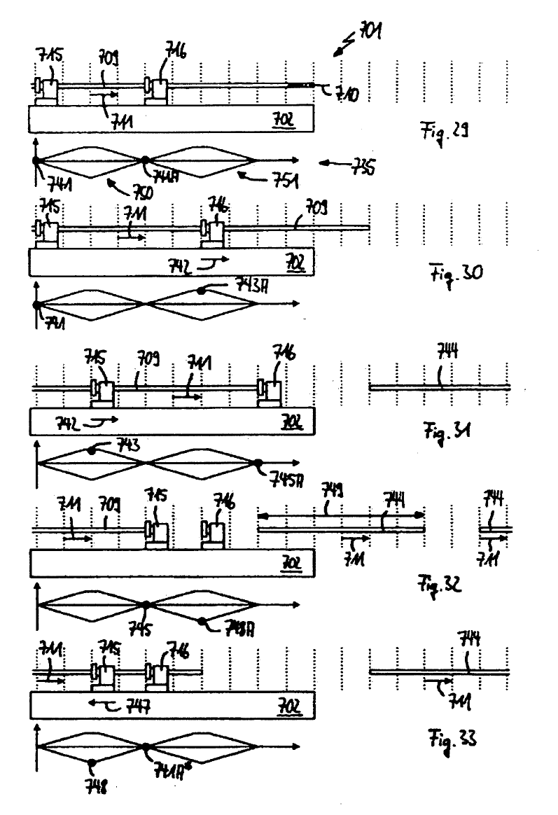

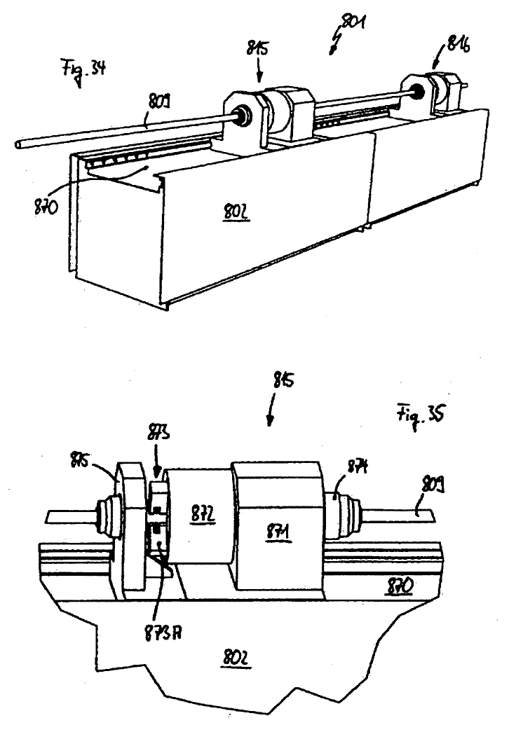

FIGS. 4 to 8 schematically show a movement and cutting sequence of a single cutter with a cutting carriage in relation to a speed/position diagram,

FIGS. 9 to 13 schematically show an in-phase movement and cutting sequence of a tandem cutter comprising two cutting carriages driven independently of one another in relation to a speed/position diagram,

FIGS. 14 to 18 schematically show an in-phase movement and cutting sequence of a tandem cutter comprising two cutting carriages driven independently of one another in relation to a speed/position diagram with overlapping movement paths,

FIGS. 19 to 28 schematically show a phase-shifted movement and cutting sequence of a tandem cutter comprising two cutting carriages driven independently of one another in relation to a speed/position diagram,

FIGS. 29 to 33 schematically show a phase-shifted movement and cutting sequence of a tandem cutter comprising two cutting carriages driven independently of one another in relation to a speed/position diagram,

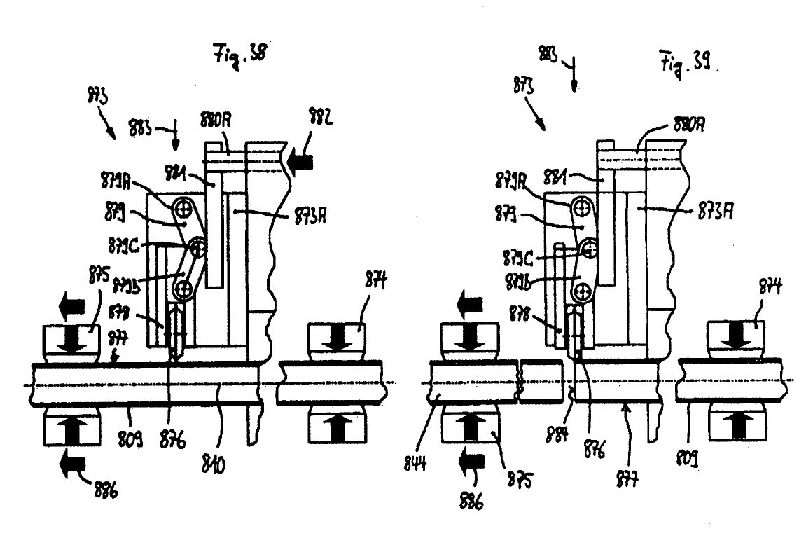

FIG. 34 is a schematic perspective view of a further tandem cutter comprising two cutting carriages driven independently of one another,

FIG. 35 is a schematic perspective view of a cutting head of a cutting carriage,

FIG. 36 is a schematic cross-section of the cutting head from FIG. 35,

FIG. 37 is a schematic longitudinal section of the cutting head from FIGS. 35 and 36 and

FIGS. 38 and 39 schematically show a cutting process using the cutting head from FIGS. 35 to 37 and

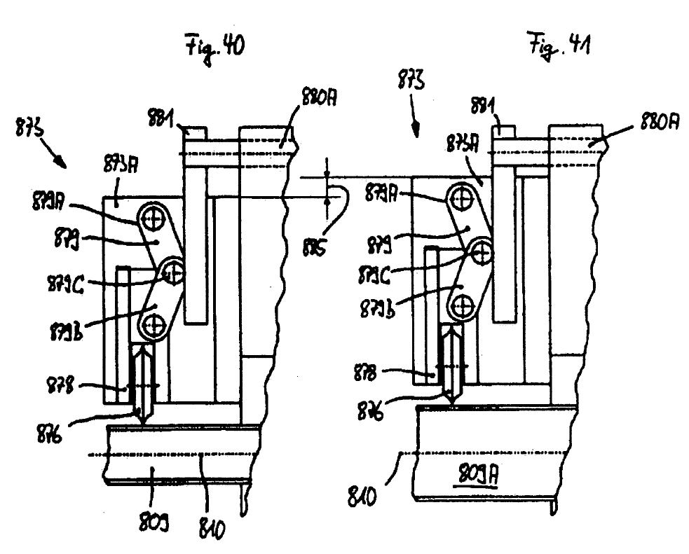

FIGS. 40 and 41 show the cutting head for different tube diameters.

The tandem cutter 1 shown in FIG. 1 comprises a framework 2 with an inlet region 3 and an outlet region 4. The inlet region 3 comprises a first inlet region roller 5 and a second inlet region roller 6. Accordingly, the outlet region 4 comprises a first outlet region roller 7 and a second outlet region roller 8. By means of the rollers 5, 6, 7 and 8 a tube 9 is substantially guided and moved along a workpiece axis 10 according to the conveying direction 11 from the inlet region 3 to the outlet region 4 through the tandem cutter 1.

In the present exemplary embodiment, between the inlet region 3 and the outlet region 4 there is provided an inlet region guide 12, a middle region guide 13 and an outlet region guide 14 which, in a suitable configuration, serve as workpiece holders or intermediate workpiece holders to guide the tube 9 or an already-cut tube piece (not shown here) of the tube 9 additionally to or independently of the rollers 5, 6, 7, 8 and/or additionally to or independently of the cutting carriages 15 or 16 along the tandem cutter 1. In this case, these guides can be configured actively or passively, that is drivingly or merely guidingly. Optionally, the guides 12, 13 and/or 14 can also serve to receive sensors (not explicitly shown here) such as, for example, an inductively operating sensor. In principle, all sensors suitable for determining the speed and/or the position of the workpiece or the position of a workpiece region are suitable as sensors. In this respect, particular mention may be made of the aforesaid inductively operating sensors. However, optical sensors or ultrasound sensors can also be used. Speed-sensitive sensors such as, for example, optical sensors or ultrasound sensors using the Doppler effect appear to be particularly suitable.

In addition, the first cutting carriage 15 and the second cutting carriage 16 move forwards and backwards independently of one another between the inlet region 3 and the outlet region 4 along the workpiece axis 10 in relation to the conveying direction 11.

The tube length of a tube piece to be produced can be varied depending on how the first cutting carriage 15 and the second cutting carriage 16 move with respect to one another in their respective reciprocating regions 17, 18, for example, with an in-phase forward and backward movement or phase-shifted with respect to one another. The reciprocating region 17 of the first cutting carriage 15 extends substantially between the inlet region guide 12 and the middle region guide 13 whereas the reciprocating region 18 of the second cutting carriage 16 extends substantially between the outlet region guide 14 and the middle region guide 13.

The tandem cutter 101 shown in FIG. 2 has substantially the same structure as the tandem cutter 1 from FIG. 1. It thus comprises a frame 102 with an inlet region 103 and an outlet region 104. The inlet region 103 comprises inlet region rollers 105 and 106, the outlet region 104 comprises outlet region rollers 107 and 108. A tube 109 is guided in the conveying direction 111 through the tandem cutter 101 along a workpiece axis 110. In this exemplary embodiment, the tandem cutter 101 merely comprises a middle region guide 113 which takes over the workpiece guiding functions and which is supplemented by an optically operating sensor 120 which is placed stationarily directly behind the inlet region 103. In this exemplary embodiment, a first cutting carriage 115 and a second cutting carriage 116 also move forwards and backwards between the inlet region 103 and the outlet region 104.

In contrast to the tandem cutter 101 from FIG. 2, another tandem cutter 201 (see FIG. 3) has two mobile optical sensors 225 and 226 on a workpiece axis 210. In addition, a fixed intermediate guide 213 is provided on which, in this exemplary embodiment, no sensor is provided unlike the previously described exemplary embodiments.

The two optical sensors 225 and 226 are displaceable along the workpiece axis 210. In order to achieve this in a structurally particularly simple manner, the first mobile optical sensor 225 is secured to a first cutting carriage 215 and the second mobile optical sensor 226 is secured to a second cutting carriage 216. The two optical sensors 225, 226 can in this case substantially detect the position and in particular also the exact speed of a tube 209 which is conveyed in accordance with the conveying direction 211 along the workpiece axis 210 through the tandem cutter 201 from an inlet region 203 to an outlet region 204. In the present case, the two optical sensors 225, 226 can easily follow the movement of the tube 209 via the cutting carriages 215 and 216.

The cutting carriages 215, 216, guided on a frame 202, move forwards and backwards in the manner already described for the preceding exemplary embodiments between the inlet region 203 and the outlet region 204 with respect to the conveying direction 211 and in this exemplary embodiment, the inlet region 203 also comprises two inlet region rollers 205 and 206 and the outlet region 204 comprises two outlet region rollers 207 and 208.

The known single cutter 330 shown in FIGS. 4 to 8 which is substantially depicted to explain the movement sequence and the object forming the basis of the tandem cutter according to the invention, comprises a frame 302 on which a cutting carriage 315 is movably mounted. The single cutter 330 has a workpiece axis 310 along which a tube 309 is moved according to the conveying direction 311.

The movement sequence of the cutting carriage 315 is illustrated in detail in a coordinate system 335 in which the respectively current position of the cutting carriage 315 is plotted on the abscissa 336 and the speed of the cutting carriage 315 present at the respective location is plotted on the ordinate 337. In this case, an upper curve 338 (positive) shows the speed profile of the cutting carriage 315 in its forward movement, that is in the conveying direction 311. A lower curve 339 (negative) shows the speed profile of the cutting carriage in its backward movement, that is opposite to the conveying direction 311. The current position of the cutting carriage 315 in the speed/position coordinate system 335 is characterised by a position marker 340.

In the exemplary embodiment shown in FIGS. 4 to 8, the cutting carriage 315 according to FIG. 4 is located in its starting position 341 with zero velocity. In the further profile (see FIG. 5), the cutting carriage 315 is accelerated to the conveying speed 342 which corresponds to the speed of the tube 309 in the conveying direction 311. During the period of time in which the cutting carriage 315 is moved at the conveying speed 342, the tube 309 is cut and a desired tube piece 344 (see FIG. 6) is separated from the tube 309. The cutting carriage is then braked and in a reversing position 345, the forward movement of the cutting carriage 315 is converted into a backward movement 347, where the cutting carriage 315 is initially accelerated and is braked from a braking position 348 into a starting position* 341* and the tube runs further at constant speed 346.

The location of the starting position 341 and the location of the starting position* 341* are identical but the additional marker * indicates that the starting position* 341* is adopted after the starting position 341 in time.

Tube pieces 344 of a first tube length 349 can be cut from a tube 309 by means of the single cutter 330.

The process sequence shown in FIGS. 9 to 13 shows a tandem cutter 401 comprising a frame 402 on which a first cutting carriage 415 and a second cutting carriage 416 are mounted. A tube 409 is moved in accordance with the conveying direction 411 along a workpiece axis 410 of the tandem cutter 401.

The movement sequences of the two cutting carriages 415, 416 are illustrated in a speed/position coordinate system 435. Since in this exemplary embodiment both cutting carriages 415, 416 are operated with an identical movement pattern, two identical movement graphs 450 and 451 are obtained in the speed/position coordinate system 435, where the first movement graph 450 shows the movement sequence of the first cutting carriage 415 and the second movement graph 451 shows the movement sequence of the second cutting carriage 416.

For the sake of clarity, the two identical movement sequences of the two cutting carriages 415, 416 are explained substantially by reference to the first movement graph 450. Furthermore, the two movement graphs 450, 451 each correspond to the representation of the speed/position coordinate system 335 of the single cutter 330.

The cutting carriage 415 is accelerated from a starting position 441 and the cutting carriage 416 is accelerated from a starting position 441A each to a conveying speed 442, whereby the cutting carriage 415 cuts the tube 409 in a cutting position 443 and the cutting carriage 416 cuts the tube 409 in a cutting position 443A, ideally substantially at the same time, into individual tube pieces 444 having the second tube length 449.

When the cutting processes have take place, the two cutting carriages 415, 416 are braked and the forward movement is converted into a backward movement 447 at a reversing position 445, 445A. From a braking position 448 or 448A the backward movement 447 is braked down into a further starting position* 441* or 441A* so that the next cutting cycle can begin.

As can be seen immediately, in this exemplary embodiment under the same boundary conditions, that is at the same speed 446 of the tube 409 and at the same maximum speed of the cutting carriage or the same minimum cycle time, twice as many short tube pieces 444 can be cut to length by this procedure compared to the tube pieces 344 with the single cutter 330 according to FIGS. 4 to 8. This is also shown by the corresponding dotted lines in the figures.

As an example, FIGS. 14 to 18 show an in-phase movement cycle by reference to another tandem cutter 501 and speed/position coordinate system 535 assigned thereto, whereby even shorter tube pieces 544 having a third tube length 549 can be cut out from a tube 509.

In this exemplary embodiment, the two movement sequences of a first cutting carriage 515 and a second cutting carriage 516 overlap at least in an overlap region 556. The movement sequences of the two cutting carriages 516, 515 are otherwise identical and correspond in the present case to a first movement graph 550 and a second movement graph 551 which are superposed in the overlap region 556.

The movement cycle of the first cutting carriage 515 starts in a first starting position 541 whereas the movement cycle of the second cutting carriage 516 begins in a second starting position 541A. The two cutting carriages 515, 516 are accelerated to a conveying speed 542 (FIG. 15) and on reaching the conveying speed 542, cut the tube 509. This forward movement 542 is then braked into a reversing position 545 or 545A (FIG. 16) and converted into a backward movement 547 (FIG. 17) so that the two cutting carriages 515, 516 each reach a starting position* 541* or 514A*.

A prerequisite for the shorter tube pieces 544 having the third tube length 549 is, however, either a lower workpiece speed 546 of the tube 509 or a high cycle or maximum speed of the cutting carriages 515, 516. Otherwise tube pieces 544 of nonuniform length are cut to length in this procedure. In particular, as a result of the overlap however, corresponding tube piece lengths can be achieved under restricted spatial conditions such as, for example, a restricted maximum length for the frame 502, if the speed of the cutting carriages 515, 516 can be selected to be sufficiently high.

As shown for example in FIGS. 19 to 28, the tube pieces 644 to be cut having a fourth tube length 649 (see FIG. 21) can also be varied by the movement sequences of cutting carriages 615, 616 being phase-shifted, as is shown by reference to a first movement graph 650 and a second movement graph 651. As a result of this phase shift, the tube length 649 of the cut tube piece 644 can be varied for the same overall configuration.

According to the diagram according to FIG. 19, the first cutting carriage 615 is located in a starting position 641 whereas the second starting carriage 616 is located in a reversing position 645A in which it waits. A tube 609 is guided through the tandem cutter 601 in the conveying direction 611.

The first cutting carriage 615 is now accelerated to a conveying speed 642 (FIG. 20) whereby it cuts the tube 609 guided through the tandem cutter 601 in a cutting position 643. The second cutting carriage 616 now waits as before in the reversing position 645A. After the cutting process, the first cutting carriage 615 is moved further into a first reversing potion 645. According to the diagram in FIG. 21, the two cutting carriages 615, 616 are located in their respective reversing position 645, 645A. From these reversing positions 645, 645A the two cutting carriages 615, 616 are accelerated by means of a backward movement 647 into a braking position 648 or into a braking position 648A and are finally moved back from this braking position 648 or 648A into another first starting position* 641* or into a second starting position 641A so that the movement cycle of the tandem cutter 601 can begin anew (see FIG. 23).

Both cutting carriages 615, 616 stay there for a moment until sufficient tube 609 has been guided further in the conveying direction 611 (see FIG. 24). Only then is the second cutting carriage 616 accelerated in the conveying direction and cuts a further tube piece 644 having the tube length 649 in the second cutting position 643A whilst the first cutting carriage 615 still remains in its starting position* 641* (see FIG. 25).

The first cutting carriage 651 is then accelerated in the conveying direction 611 to the conveying speed 642 in order to again cut through the tube 609 in the first cutting position* 643* and the second cutting carriage 616 is moved back again into the second reversing position 645A*. When another tube piece 644 having the tube length 649 is cut by means of the first cutting carriage 615 (FIG. 26), the first cutting carriage 615 again moves back into its first reversing position* 645*.

Both cutting carriages 615, 616 are now accelerated with the backward movement 647 as far as the respective braking position 648* and 648A* before then again reaching the first starting position* 641* or the starting position 641A (see FIG. 23). In this way, a cyclic advance can then be made. FIGS. 26 to 28 correspond in their movement sequence to FIGS. 20 to 22 whereas FIG. 19 describes an ingoing movement.

As can be immediately seen, the cutting carriages 615, 616 dwell temporarily in their starting positions 641, 641A or reversing positions 645 and 645A. In this respect, the phase profile shown is not essential but can be varied as required. In this exemplary embodiment it is assumed that the cutting carriages 615, 616 are each accelerated at their maximum accelerations, that is they increase or retard their speed. In this respect, waiting times are provided, whereby it is immediately clear that these waiting times determine the tube length 649 which can be cut and in this way longer tube lengths 649 than in the previously described tandem cutters are provided. As can be immediately seen, the shortest tube lengths can be cut with in-phase sequences and maximum cycle speed. The tube length can then be arbitrarily lengthened by means of the phase shift and a lengthening of the cycle time until ultimately only one cutting carriage is sufficient to cut the desired tube length under given boundary conditions such as workpiece speed and maximum carriage speed.

FIGS. 29 to 33 illustrate another movement sequence of a first cutting carriage 715 and a second cutting carriage 716 of a tandem cutter 701. The two cutting carriages 715, 716 are guided on a frame 702 of the tandem cutter 701 and the two cutting carriages 715, 716 can be displaced according to a forward movement 742 and a backward movement 747. In this case, the two cutting carriages 715, 716 cut a tube 709 into tube pieces 744 having a fifth tube length 749 which are moved in the conveying direction 711 along a tool axis 710 of the tandem cutter 701.

The movement sequences of the first cutting carriage 715 are plotted in the first movement graph 750 and the movement sequences of the second cutting carriage 716 are plotted in the second movement graph 751. According to the representation of the speed/position coordinate system 735 from FIG. 29, both cutting carriages 715, 716 are located in a starting position 741 or in a starting position 741A.

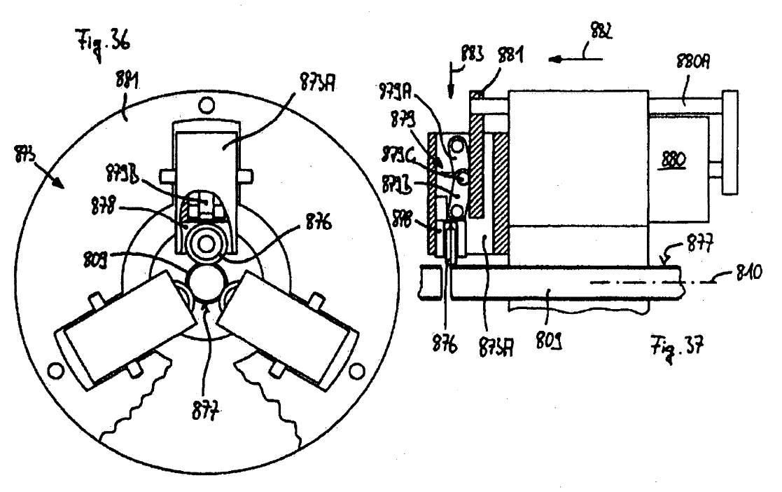

In this exemplary embodiment, the second cutting carriage 716 as the first of the two cutting carriages 715, 716 executes a forward movement and is hereby accelerated to the conveying speed 742 (see FIG. 30). When the second cutting carriage 716 has reached a second cutting position 743A, the tube 709 is cut there into tube pieces 744 having the fifth tube length 749 by means of the second cutting carriage 716.

The second cutting carriage 716 is then moved further into a second reversing position 745A (see FIG. 31) whilst the first cutting carriage 715 was accelerated to the conveying speed 742 into a first cutting position 743. Having reached the first cutting position 743, the first cutting carriage 715 likewise cuts the tube 709 into tube pieces 744 having the tube length 749.

The two cutting carriages 715, 716 each move further by themselves but synchronously and phase-shifted (see FIG. 32), whereby the first cutting carriage 715 is brought into a first reversing position 745. During this, the second cutting carriage 716 is already in a backward movement 747 and in a second braking position 748A.

The second cutting carriage 716 again reaches a starting position 741A* whilst the first cutting carriage 715 is still in its backward movement 747 in a braking position 748. When the first cutting carriage 715 also reaches a starting position (not shown here), the entire movement cycle of the tandem cutter 701 begins anew.

It is understood that the movement sequences shown in FIGS. 4 to 33 can be carried out with a single installation. This applies particularly if the cutting carriages can be displaced completely independently of one another. On the other hand, the sequences according to FIGS. 3 to 18 can also be carried out with installations in which the cutting carriages are rigidly connected to one another. In addition, it is understood that further cutting carriages can be provided if the boundary conditions such as the given tube speed and the actual duration of a cutting process and the minimum cycle time do not permit cutting with a desired tube length using two cutting carriages running in phase at the maximum cycle speed. It is also understood that the cutting carriages need not necessarily cover overlapping or contacting paths depending on the specific travel guidance. Likewise, the path length can be varied as required. In more complex movement sequences, in particular when tubes having different lengths are to be cut to length, synchronisation of the cutting carriages is likewise not absolutely necessary.

The tandem cutter 801 shown in detail in FIGS. 34 to 41 comprises a frame 802 with a travel bed 870 on which a first cutting carriage 815 and a second cutting carriage 815 are displaceably mounted and can implement the preceding sequences. A tube 809 allocated to the tandem cutter 801 is cut to length by means of the two cutting carriages 815, 816.

The structure of the first cutting carriage 815 is shown schematically in detail by reference to the diagrams in FIGS. 35 to 41, the second cutting carriage being correspondingly configured.

The cutting carriage 815 comprises a drive 871 which drives a rotary chuck 872 with a cutting head 873 disposed thereon as a circulating cutting device. At the end of the drive 871 opposite to the rotary chuck 872, a tube clamping mechanism 874 is provided as a first retaining device by which means the tube 809 or a part of the tube 809 can be clamped and in particular fixed in relation to the cutting carriage 815.

Furthermore, in the area of the cutting head 873 a tube stroke clamping mechanism 875 is provided as a further retaining device by which means the tube 809 or a part of the tube 809 can be clamped and in particular fixed in relation to the cutting carriage 815. In addition, a tube 809 clamped by means of the tube clamping mechanism 874 can be stressed by means of the tube stroke clamping mechanism 875 since the tube stroke clamping mechanism 875 can be displaced with respect to the tube clamping mechanism 874.

When the tube 809 is subjected to tensile stress in such a manner, cutting means in the form of cutting blades 876 (see FIGS. 36 to 41) of the cutting head 873 cut into the tube 809 circumferentially at least on the circumferential surface 877 of the tube 809. Thus, the present cutting blades 876 are rotating cutting blades which run externally around the outside diameter. The cutting blades 876 are fixed on the cutting blade holder 878 (numbered only as an example here) so that they can be displaced radially to the tube 809. The cutting blade holders 878 in turn are disposed radially adjustably on retaining jaws 873A of the cutting head 873. The retaining jaws 873A are preferably adjusted synchronously to thus achieve a uniform movement of all the retaining jaws 873A with respect to the workpiece axis 810.

The advantage with such a construction can be seen, inter alia, in that the cutting carriages 815 and 816 can be adapted rapidly and structurally simply to different-sized workpiece diameters by means of the retaining jaws 873A which can be adjusted radially to the workpiece axis 810 (see FIGS. 40 and 41). On the other hand, simple and rapid delivery of the cutting blades 876 is possible before, during and after the cutting by means of the cutting blades 876 being radially displaceable with respect to the tube 809 (see FIGS. 38 and 39).

The cutting head 873 comprises a toggle lever mechanism 879 by which means a force 882 running axially to a workpiece axis 810 or to the tube 809 (see FIG. 37) is converted into a radially acting force 883.

The toggle lever mechanism 879 comprises a first toggle lever 879A which is fixed in an articulated manner to a retaining jaw 873A. Another toggle lever 879B is connected to the cutting blade holder 878 in an articulated manner. Both toggle levers 879A, 879B of the present toggle lever mechanism 879 are connected to one another in an articulated manner in a toggle lever joint 879C. Since such toggle lever mechanisms are sufficiently known from the prior art, the present toggle lever mechanism 879 is not explained further.

The axially running force 882 is generated by means of a cylinder 880 and transferred by means of a cylinder rod 880A and a thrust plate 881 to the toggle lever mechanism 879. In this case, the thrust plate 881 is displaceable parallel to the workpiece axis 810.

By means of the radially acting force 883, the cutting blades 876 are pressed against the tube 809 and cut into the tube 809 on its circumferential surface 877 until the tube 809, which is additionally under tensile stress, ruptures at the cutting point 884 (see FIGS. 38 and 39). In the present case, the opening of the cutting blades 876 is advantageously achieved by means of centrifugal forces which are provided by the rotational speed of the cutting head 873. In an alternative embodiment, the cutting blades are entirely displaced by means of centrifugal forces which can be adjusted by varying the rotational speed of the cutting head and act against a bias such as, for example, against pressing springs or similar.

The diagrams in FIGS. 38 and 39 explicitly illustrate the interplay between the cutting head 873, the tube clamping mechanism 874 and the tube stroke clamping mechanism 875.

In preparation for a cutting process, the tube 809 is clamped on a first side of the cutting carriage 815 by means of the tube clamping mechanism 874. On the opposite side the tube 809 is correspondingly clamped by means of the tube stroke clamping mechanism 875. In this case, the tube stroke clamping mechanism 875 is displaced with respect to the other components, in particular with respect to the tube clamping mechanism 874 so that the tube 809 is under tensile stress 886. At the same time, an axial force 882 is exerted on the cylinder rod 880A with the result that the thrust plate 881 is moved towards the toggle lever mechanism 879. The toggle lever mechanism 879 is hereby brought into a more stretched position (see FIG. 39) whereby the cutting blade holder 878 and therefore also the cutting blade 876 is moved in the direction of the workpiece axis 810. As a result of this delivery movement and the rotation of the cutting head 873, the tube 809 is hereby cut at least on its circumferential surface 877. As a result of the tensile stressing of the tube 809, the tube thus scored breaks at the cutting point 884.

The centrifugal forces move the cutting blades 876 back into the initial position as a result of the cylinder rod 880A being unloaded.

In order that different tube diameters of a tube 809 or 809A (see FIGS. 40 and 41) can advantageously be cut with the present cutting carriage 815, 816, the retaining jaws 873A (only numbered explicitly here) are moved back over a distance 885 from the workpiece axis 810. The cutting blades 876 are thereby also moved away from the workpiece axis 810 so that additional space is provided for guiding a workpiece having a larger diameter along the workpiece axis 810 through the two cutting carriages 815, 816.

### REFERENCE LIST

1 Tandem cutter
2 Frame
3 Inlet region
4 Outlet region
5 First inlet region roller
6 Second inlet region roller
7 First outlet region roller
8 Second outlet region roller
9 Tube
10 Workpiece axis
11 Conveying direction
12 Inlet region guide
13 Middle region guide
14 Outlet region guide
15 First cutting carriage
16 Second cutting carriage
17 First reciprocating region
18 Second reciprocating region
101 Tandem cutter
102 Frame
103 Inlet region
104 Outlet region
105 First inlet region roller
106 Second inlet region roller
107 First outlet region roller
108 Second outlet region roller
109 Tube
110 Workpiece axis
111 Conveying direction
113 Middle region guide
115 First cutting carriage
116 Second cutting carriage
120 Optically operating sensor
201 Tandem cutter
202 Frame
203 Inlet region
204 Outlet region
205 First inlet region roller
206 Second inlet region roller
207 First outlet region roller
208 Second outlet region roller
209 Tube
210 Workpiece axis
211 Conveying direction
213 Intermediate guide
215 First cutting carriage
216 Second cutting carriage
225 First mobile sensor
226 Second mobile sensor
302 Frame
309 Tube
310 Workpiece axis
311 Conveying direction
315 Cutting carriage
330 Single cutter
335 Coordinate system
336 Abscissa
337 Ordinate
338 Upper curve
339 Lower curve
340 Position marker
341 Starting position
341* Starting position*
342 Conveying speed of cutting carriage
343 First cutting position
343A Second cutting position
344 Tube pieces
345 Reversing position
346 Conveying speed of tube
347 Backward movement
348 Braking position
349 First tube length
401 Tandem cutter
402 Frame
409 Tube
410 Workpiece axis
415 First cutting carriage
416 Second cutting carriage
441 Starting position
441* Starting position*
441A Starting position
441A* Starting position*
442 Conveying speed of cutting carriage
443 First cutting position
443A Second cutting position
444 Tube pieces
445 First reversing position
445A Second reversing position
446 Conveying speed of tube
447 Backward movement
448 Braking position
448A Braking position
449 Second tube length
450 First movement graph
451 Second movement graph
501 Tandem cutter
502 Frame
509 Tube
511 Conveying direction
515 First cutting carriage
516 Second cutting carriage
535 Speed/position coordinate system
541 First starting position
541* First starting position*
541A Second starting position
541A* Second starting position*
542 Conveying speed of cutting carriage
543 First cutting position
543 Second cutting position
544 Tube pieces
545 First reversing position
545A Second reversing position
546 Conveying speed of tube
547 Backward movement
548 First braking position
548A Second braking position
549 Third tube length
550 First movement graph
551 Second movement graph
556 Overlap region
601 Tandem cutter
602 Frame
609 Tube
611 Conveying direction
615 First cutting carriage
616 Second cutting carriage
641 First starting position
641* First starting position*
641A Second starting position
642 Conveying speed of cutting carriage
643 First cutting position
643* First cutting position*
643A Second cutting position
644 Tube pieces
645 First reversing position
645* First reversing position*
645A Second reversing position
645A*Second reversing position*
646 Conveying speed of tube
647 Backward movement
648 First braking position, first braking position*
648A Second braking position, second braking position*
649 Fourth tube length
650 First movement graph
651 Second movement graph
701 Tandem cutter
702 Frame
709 Tube
710 Workpiece axis
711 Conveying direction
715 First cutting carriage
716 Second cutting carriage
741 First starting position
741A Second starting position
741A* Second starting position*
742 Conveying speed of cutting carriage
743 First cutting position
743 Second cutting position
744 Tube pieces
745 First reversing position
745 Second reversing position
746 Conveying speed of tube
747 Backward movement
748 Braking position
759 Fifth tube length
750 First movement graph
751 Second movement graph
801 Tandem cutter
802 Frame
809 Tube
809A Tube having larger diameter
810 Workpiece axis
815 First cutting carriage
816 Second cutting carriage
844 Tube piece
871 Drive
872 Rotary chuck
873 Cutting head
873A Retaining jaws
874 Tube clamping mechanism
875 Tube stroke clamping mechanism
876 Cutting blade
877 Circumferential surface of tube
878 Cutting blade holder
879 Toggle lever mechanism
879A First toggle lever
879B Further toggle lever
879C Toggle lever joint
880 Cylinder
880A Cylinder rod
881 Thrust plate
882 Axial force
883 Radially acting force
884 Cutting position
885 Distance
886 Tensile stressing

1. A cutting device for substantially linear workpieces, in particular for substantially continuously fed linear workpieces, in which a cutting carriage is moved together with the workpiece and a cutting device provided on the cutting carriage cuts the workpiece during this movement and in which the cutting device is comprising at least two successively arranged cutting carriages.

2. The cutting device according to claim 1, wherein at least one cutting carriage (15, 16) is driven independently of the other cutting carriage (15, 16) for its movement with the workpiece.

3. The cutting device according to claim 2, wherein the movement paths of the cutting carriages (15, 16) overlap.

4. The cutting device according to claim 1, wherein a workpiece guide is provided on at least one cutting carriage (15, 16).

5. The cutting device according to claim 1, comprising an intermediate workpiece guide (12, 13, 14) which is disposed between two cutting carriages (15, 16) independently of their movement sequence.

6. The cutting device according to claim 5, wherein the intermediate workpiece guide (12, 13, 14) is disposed in a fixed position.

7. The cutting device according to claim 5, wherein the intermediate workpiece guide (12, 13, 14) is disposed so that it can move jointly with the workpiece (9).

8. A cutting device for substantially linear workpieces, in particular for substantially continuously fed linear workpieces, in particular according to claim 1, in which a cutting carriage is moved together with the workpiece and a cutting device provided on the cutting carriage cuts the workpiece during this movement, wherein at least two retaining devices are provided on the carriage which, when viewed along the workpiece axis, are disposed on both sides of a cutting device, wherein at least one of the two retaining devices (874, 875) can be moved along the workpiece axis (810) relative to the other retaining device (875) and/or relative to the cutting carriage (815) or relative to the cutting device.

9. The cutting device according to claim 8, wherein the cutting device (815, 816) comprises a rotating chuck (872) for a cutting tool (876) which comprises at least one radially displaceable cutting blade holder (878) for at least one cutting tool (876) and means for radial displacement of the cutting blade holder (878) for a cutting process, wherein the displacement means comprises a toggle lever (879).

10. The cutting device according to claim 9, wherein one arm of the toggle lever (879) is disposed on the cutting blade holder (878) and the other arm of the toggle lever (879) is disposed on a retaining part (retaining jaw 873A) for the cutting tool (876) and the displacement means acts on the elbow.

11. The cutting device according to claim 9, wherein the displacement means comprise a thrust plate (881), preferably a thrust plate (881) circulating with the cutting device (815, 816).

12. The cutting device according to claim 8, wherein the cutting device (815, 816), in particular a cutting head (873) of the cutting device (815, 816) is opened by centrifugal forces.

13. The cutting device according to claim 8, comprising means for radial adjustment of the cutting means with regard to different workpiece diameters.

14. The cutting device according to claim 13, wherein the adjusting means comprise retaining jaws on which the cutting means or cutting-means holders are mounted.

15. The cutting device according to claim 14, wherein a toggle lever, in particular an arm of a toggle lever, is mounted on the retaining jaws.

16. The cutting device according to claim 14, wherein the retaining jaws are mounted radially displaceably on the cutting carriage in relation to a workpiece axis.

17. A method for cutting substantially linear workpieces, in particular substantially continuously fed linear workpieces by means of a cutting device, wherein the workpiece is gripped on both sides of a parting surface and is cut under tension with the cutting device at the parting surface.

18. The cutting method according to claim 17, wherein the cutting process and the pulling are matched to one another in such a manner that the parting edge (884) thus produced comprises an expanded tube wall and/or a tear or break edge.

19. The cutting method according to claim 17, wherein the cutting device is moved with the workpiece during the cutting.

20. A method for cutting substantially linear workpieces, in particular substantially continuously fed linear workpieces, by means of a cutting device, which is moved with the workpiece during cutting, wherein the workpiece is gripped on both sides of a parting surface and is cut under tension and/or break.

21. The method for cutting substantially linear workpieces, in particular substantially continuously fed linear workpieces, in particular according to claim 17, wherein two successively arranged cutting carriages are moved to and fro with a phase difference.

22. The cutting method according to claim 17, wherein a cutting device rotating around the workpiece is moved on a cutting carriage with the workpiece during cutting and rotates around said workpiece for the cutting.
